(19) United States
(12) Patent Application Publication
(10) Pub. No.: US 2010/0139949 A1
(43) Pub. Date: Jun. 10, 2010

(54) SPLICE WIRE HOLDER

(76) Inventors: Alfredo Haros Hernandez, Colonia Obrerista (MX); Gumaro Carrizales Espinosa, Colonia Rincon de Huinala (MX); Leoncio Trejo Aguilar, Colonia Privadas de Santa Rosa (MX)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/330,775

(22) Filed: Dec. 9, 2008

(51) Int. Cl. H01B 7/00

(52) U.S. Cl. 174/135

(57) ABSTRACT

A device for maintaining the separation and position of spliced wires within a mold is provided. The device is characterized by multiple pointed portions which extend radially outward to a tip. The portions between the tips are radially depressed, with holes placed near the radially innermost point of the outer surface of the device. The holes are incomplete due to notches on the radially outermost portion of the holes which allow wires to be pressed into the holes in a radially inward direction. The device, with wires mounted therein, may be placed into an injection mold and maintains the separation of the exposed conductors until the over-molding process is complete. The device also prevents the wires from touching the edge of the mold during the injection process thereby minimizing any show-through defects in the finished product.

### TECHNICAL FIELD OF THE INVENTION

The present disclosure relates generally to electrical wiring devices and, more particularly, to a device for holding spliced wires in position within a mold.

### BACKGROUND OF THE INVENTION

Splices are often used to connect wires in electrical circuits. Various methods and devices are known in the art for achieving a safe and functional splice. One method that is commonly used involves stripping the insulation near the ends of the conductors to be joined, soldering or welding the exposed conductors to form an electrical connection, placing the stripped portions of the wires into a mold, and injecting plastic or other dielectric material into the mold to form a permanent protective and insulating layer around the splice. This protective layer is commonly referred to as an “over-mold.”

One problem, however, is that the exposed conductors need to be held in a specific location within the mold during the injection process. This ensures that the bare conductors are fully surrounded by the over-mold material and are insulated from the outside environment. When multiple wiring nodes are connected inside a single mold, placement becomes even more critical to ensure that the individual conductors are adequately separated, thereby avoiding a short circuit.

Proper placement within the mold can be made difficult by a number of factors. For example, the stiffness of a heavy gauge wire may be hard to overcome when attempting to center the spliced portion of a wire within the mold. On the other hand, wires that are excessively flimsy may tend to move within the mold after placement. The wires may also move during the over-molding process due to pressure forces created as the over-mold material is injected into the mold cavity.

One solution known in the art is to individually wrap the welded conductors with dielectric tape. The tape prevents conductors within a multi-node splice from touching one another however the process of applying the tape is also labor intensive. Furthermore, the method does not prevent the conductors from being forced to the edge of the mold during the injection process, which may result in show-through defects in the finished over-molded product. The tape may also become deformed or compromised during the injection process due to the initial high temperature of the injected over-mold material.

Another solution is to use strategically positioned steel pins to hold the wires in place within the mold. The pins maintain separation of the individual wires and prevent the wires from touching the mold edges. After the over-molding process is complete, the pins are removed. However, the remaining holes in the molded material may allow water and other contaminants to enter the splice, causing corrosion and potentially weakening the splice connection. Like the tape method, the placement and removal of the pins adds to the labor intensity of the manufacturing process.

Methods and devices are needed to improve the accuracy by which conductors may be held in the mold cavity during the injection process, while still maintaining the ease and speed of installation required for a rapid production environment.

### SUMMARY OF THE INVENTION

Accordingly, in one aspect, a device for maintaining the position of spliced wires within a mold is disclosed comprising a plurality of pointed portions extending radially from the center of said device and narrowing to a tip in the radially-outward direction; a plurality of holes for receiving the spliced wires, said holes positioned uniformly radially about the center of said device; and a plurality of notches for mounting said spliced wires into said holes; wherein said pointed portions are equally spaced circumferentially about the center of the cross section of said device; wherein said holes are equally spaced circumferentially about the center of said device; wherein each one of said notches is positioned on the radially outward portion of one of said holes with respect to the center of said device; and wherein said notches enable said spliced wires to be mounted into said holes in a direction transverse to the linear axis of the mounted spliced wires.

According to another aspect, a device for maintaining the separation of spliced wires within an injection mold is disclosed, said device having a cross-section comprising a plurality of equally circumferentially spaced tips, said tips defining an outer diameter of the cross section of said device a plurality of surfaces between said tips, said surfaces being radially depressed from said tips with respect to the center said outer diameter a plurality of holes extending through the device for receiving the spliced wires, said holes positioned uniformly radially about the center of said device, said holes positioned uniformly circumferentially such that the center of each hole bisects the angle defined by two adjacent ones of said tips with relation to the center of said outer diameter of said device; and a plurality of notches for inserting the spliced wires into said holes, each one of said notches centered on the most radially outward point of one of said holes with relation to the center of said device.

### BRIEF DESCRIPTION OF THE DRAWINGS

FIG. 1 is a perspective view of a splice wire holder according to one embodiment.

FIG. 2 is a perspective view of the splice wire holder of FIG. 1 with spliced wires mounted therein.

FIG. 3 is a perspective view of the splice wire holder of FIG. 1 with a spliced and non-spliced wires mounted therein.

FIG. 4 is a cross sectional front view of the splice wire holder of FIG. 1 mounted within a mold.

FIG. 5 is a perspective view of a finished splice according to one embodiment after the over-molding process is complete.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

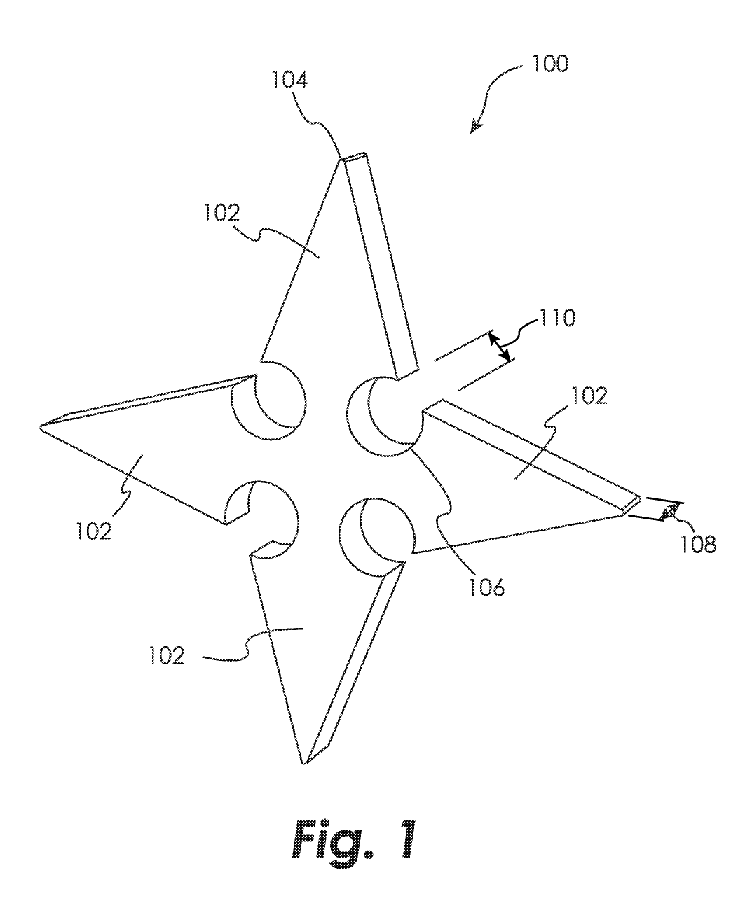

FIG. 1 shows a wire holder 100 for maintaining the placement and separation of wires within a mold cavity. In the illustrated embodiment, the wire holder 100 generally comprises a cross-sectional star shape with four pointed portions 102. The portions 102, which are equally spaced about the center of the holder 100, extend radially outward and narrow to a tip 104. The surfaces between the tips 104 are radially depressed relative to the tips 104 as illustrated. Holes 106 are also uniformly arranged about the center of the holder 100 with each hole 106 partially separating the individual portions 102. The holes 106 extend through the thickness 108 of the holder 100 to form a cylindrical opening. Each hole 106 also contains a notch 110 in the radially outward portion of the hole 106. The notches 110 are circumferentially centered between two adjacent pointed portions 102 as shown in FIG. 1. The holes 106 are preferably radially positioned such that there is sufficient separation between the individual holes 106, while still maintaining an angular size of the notch 110 of less than 180 degrees with respect to the hole 106.

The notches 110 allow wires to be pressed into the holes 106 in a radially inward direction, as opposed be being inserted linearly via the circular opening of the holes 106. This may be necessary in applications where the wires 200A and 200B are soldered or welded together prior to being mounted in the wire holder 100. In the illustrated embodiment, the thickness 108 of the holder 100 is generally uniform throughout the holder 100, although non-uniform thicknesses 108 are also contemplated by the present disclosure.

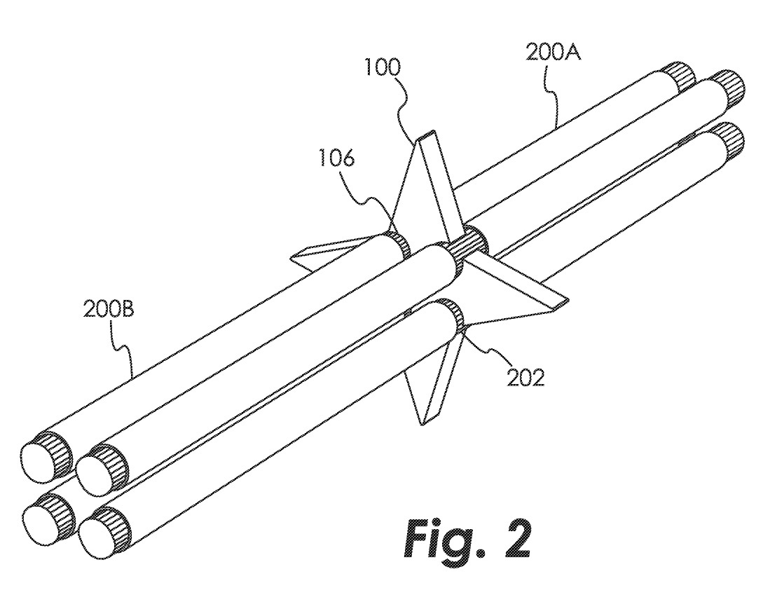

FIG. 2 shows the wire holder 100 with wires 200 installed therein. As illustrated here, each wire 200A has been partially stripped and welded to an opposing wire 200B. The exposed portions of the conductors 202 have been inserted into the holes 106 via notches 110 as described hereinabove. Due to the flexibility of the material used to form the wire holder 100, the notch 110 may be temporarily widened when mounting a wire 200 in the holder 100. After a wire 200 is mounted in the hole 106, the hole 106 and notch 110 return to their original shape and size, thereby securing the wire 200 in the holder 100.

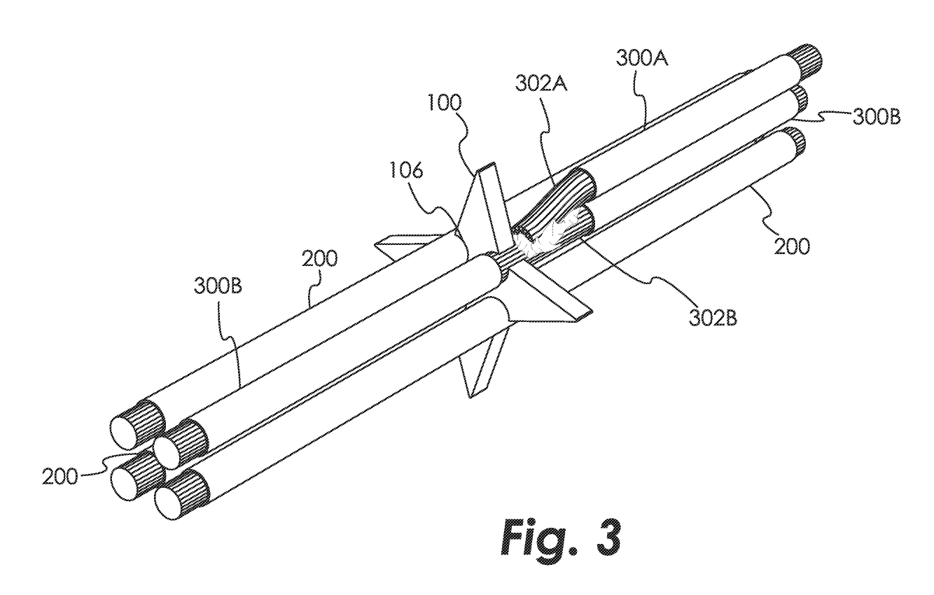

In a preferred embodiment, the diameter of the holes 106 are sized to match that of the bare conductors 202, providing a snug fit when the conductors 202 are mounted in the holes 106. In other embodiments, the diameter of the holes 106 may be made to approximate the outer diameter of the insulating jacket of the wires 200. FIG. 3 illustrates an embodiment wherein one end of a first wire 300A is stripped to expose a portion of the conductor 302A. The conductor 302A is then “Y” spliced into the conductor 302B of a second wire 300B. The spliced conductors 302 are then inserted into one of the holes 106 as illustrated. The remaining three wires 200 do not contain splices and are inserted into the remaining three holes 106 to maintain proper position.

The number of holes 106 is preferably equal to the number of pointed portions 102 of the wire holder 100. Although the illustrated embodiment comprises four holes 106 and pointed portions 102, the present disclosure contemplates that more or less than four holes 106 may be provided in the wire holder 100 to accommodate splices involving more or less than four wires 200. In addition, the diameter of the holes 106 within a particular wire holder 100 may be varied to allow wires of different diameters or gauges to be included in the same splice.

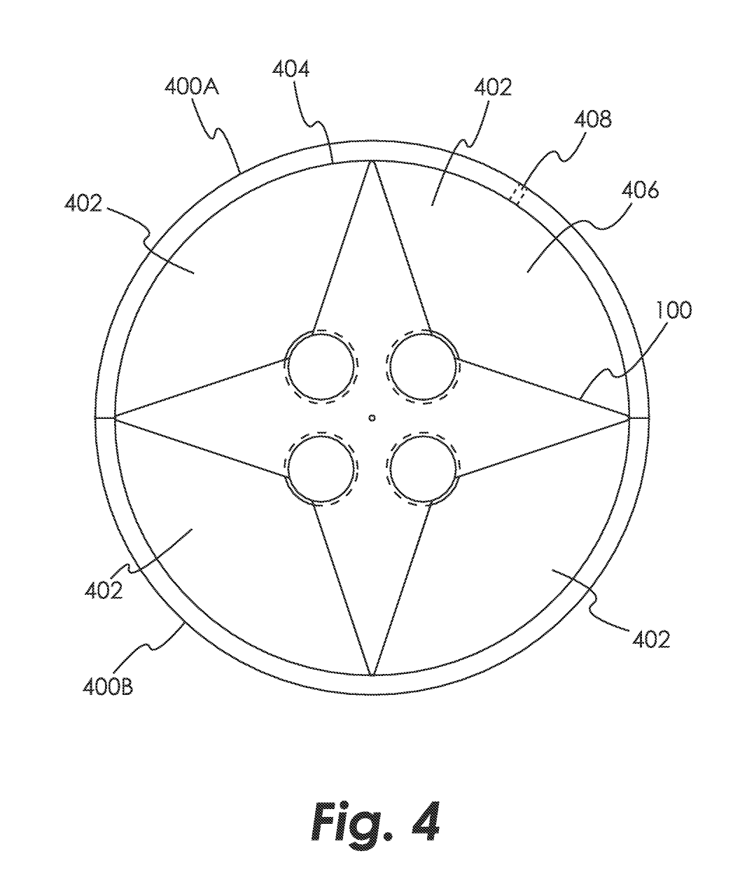

FIG. 4 shows a cross-sectional view of the wire holder 100 mounted within a mold 400. As illustrated, the mold 400 comprises a top section 400A and a bottom section 400B which lock together to form a sealed cavity 402. The mold 400 is illustrated as being circular or cylindrical in nature, although other shapes may be used. The maximum diameter of the wire holder 100 is preferably selected so that the tips 104 are held within the inner surface 404 of the mold 400 by a friction fit.

Once the wires 400 are mounted in the wire holder 100 and the wire holder 100 is secured in the mold 400, the liquid over-molding material 406 is pressure-injected into the cavity 402 via a port 408. The exact details of the injection process are not critical to the present disclosure. The over-molding material 406 surrounds the wire holder 100 and the wires 200 within the cavity 402. After the over-molding material 406 has sufficiently cooled and hardened, the mold 400 may be removed. The hardened over-molded material 406 forms a permanent protective and insulating barrier which maintains the separation of the conductors 202.

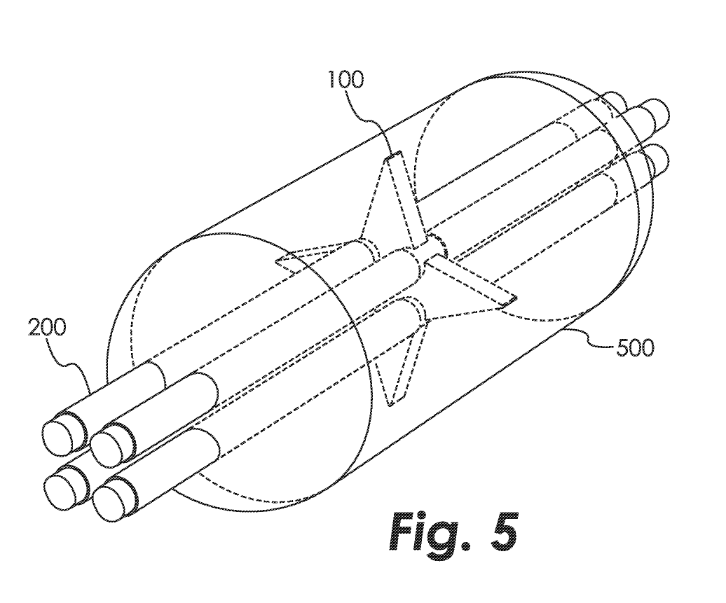

FIG. 5 shows a perspective view of a finished over-molded splice 500, with the wire holder 100 contain therein. The tips 204 of the wire holder 100 may be visible from the outside of the splice 500, although any such protrusion will normally be minimal due to the shape of the wire holder 100.

The wire holder 100 may be formed from any dielectric material suitable for insulating electrical conductors. Such materials include, but are not limited to, rubber, plastic, polyvinyl chloride (PVC), silicon, and the like. The flexibility or stiffness of the material may also be chosen depending on the required application. For example, if a very high pressure injection over-molding process is used or the wires 200 are less flexible and harder to keep in position within the mold, a stiffer material may be used to form the wire holder 100, with the notches 110 made relatively larger to allow the wires 200 to be easily pressed into the holes 106. If a lower pressure injection process is used, or the wires 200 are of a lighter gauge and do not exert as much force against the wire holder 100, the wire holder 100 can be made of a more flexible material. In that case, the notches 110 can be made smaller since they can be easily widened when the wires 200 are pressed into the holes 106 via the notches 110.

In a preferred embodiment, the injected material used to form the over-mold is the same material used to form the wire holder 100. By using the same material for both components, any show-through defects in the final product are visually minimized. In other embodiments, the wire holder 100 and the over-mold may be made of different dielectric materials. For example, the wire holder 100 may need to be made of a stiffer material than the over-mold if particularly stiff wires are being spliced as described above.

The thickness 108 of the wire holder 100 is preferably configured such that the wire holder 100 will not twist or tilt within the mold as the over-molded material is injected. As the thickness 108 is increased, the stability of the wire holder 100 is also increased.

In certain embodiments, multiple wire holders 100 may be used to secure the wires 200 within a mold 400. The additional wire holders 100 may be necessary if there is a need to separate the linear position of the individual conductor splices within the mold. In applications where a linearly long mold is used, the multiple wire holders may be used to prevent the insulated portions of the wires 200 from touching the inner surface 404 of the mold 400 and creating a show through defect.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A device for maintaining the position of spliced wires within a mold comprising:
a plurality of pointed portions extending radially from the center of said device and narrowing to a tip in the radially-outward direction; and
a plurality of holes for receiving the spliced wires, said holes positioned uniformly radially about the center of said device;
wherein said pointed portions are equally spaced circumferentially about the center of said device;
wherein said holes are equally spaced circumferentially about the center of said device.

2. The device of claim 1 further comprising:
a plurality of notches for mounting said spliced wires into said holes;
wherein each one of said notches is positioned on the radially outward portion of one of said holes with respect to the center of said device; and
wherein said notches enable said spliced wires to be mounted into said holes in a direction transverse to the linear axis of the mounted spliced wires.

3. The device of claim 2, wherein said notches are less than one hundred eighty degrees with respect to said holes.

4. The device of claim 2, wherein said notches are less than ninety degrees with respect to said holes.

5. The device of claim 2, wherein the device is formed from a material flexible enough to allow two adjacent pointed portions to be flexed circumferentially when inserting the spliced wire into one of said holes.

6. The device of claim 1, wherein the maximum dimension of the device is sized such that the tips of said pointed portions are held within the mold by a friction fit.

7. The device of claim 1, wherein the diameter of said holes is configured to substantially match the diameter of the stripped portion of the spliced conductors.

8. The device of claim 1, wherein the diameter of said holes is configured to substantially match the diameter of the insulated portion of the spliced conductors.

9. The device of claim 1, wherein the device is made of a dielectric material.

10. The device of claim 1, wherein the device is made of the same material as the material being injected into the mold, said device remaining permanently within a resulting over-molded layer.

11. The device of claim 1, wherein the number of said pointed portions is four.

12. A device for maintaining the separation of spliced wires within an injection mold, said device having a cross-section comprising:
a plurality of equally circumferentially spaced tips, said tips defining an outer diameter of the cross section of said device;
a plurality of surfaces between said tips, said surfaces being radially depressed from said tips with respect to the center said outer diameter;
a plurality of holes extending through the device for receiving the spliced wires, said holes positioned uniformly radially about the center of said device, said holes positioned uniformly circumferentially such that the center of each hole bisects the angle defined by two adjacent ones of said tips with relation to the center of said outer diameter of said device; and
a plurality of notches for inserting the spliced wires into said holes, each one of said notches centered on the most radially outward point of one of said holes with relation to the center of said device.
